(19) United States
(12) Patent Application Publication
(10) Pub. No.: US 2022/0158961 A1
(43) Pub. Date: May 19, 2022

(54) MEDIA CONTENT CAPTURE AND PRESENTATION

(71) Applicant: Twitter, Inc., San Francisco, CA (US)

(72) Inventors: Paul Stamatiou, New York City, NY (US); Reed Martin, San Francisco, CA (US); Sasank Reddy, San Francisco, CA (US); Sara Beykpour, Larkspur, CA (US); Mike Kruzeniski, San Francisco, CA (US); Sean Thompson, Boulder, CO (US)

(21) Appl. No.: 17/435,608

(22) PCT Filed: Mar. 4, 2020
(86) PCT No.: PCT/US2020/021038

§ 371 Date: Sep. 1, 2021

Related U.S. Application Data
(63) Continuation-in-part of application No. 16/292,261, filed on Mar. 4, 2019, now abandoned.
(60) Provisional application No. 62/818,086, filed on Mar. 13, 2019.

(51) Int. Cl. H04L 51/222; H04L 51/52; G06F 16/909; G06N 20/00; G06F 16/906

(52) U.S. Cl. CPC H04L 51/20; H04L 51/32; G06F 16/906; G06N 20/00; G06F 16/909

(57) ABSTRACT

Methods, systems, and apparatus, including computer programs encoded on computer storage media, for providing event-specific media content. One of the methods includes receiving, by a social messaging platform, an indication of a message by a user of client software on a first user device; receiving, from the first user device, a first location of the first user device; providing, to the first user device, one or more topics that are specific to an event temporally associated with the first location; receiving, the message for posting on the social messaging platform, the message including (i) a topic selected from the one or more topics, and (ii) user selected media content; and adding the message to one or more streams of the social messaging platform.

### CROSS-REFERENCE TO RELATED APPLICATIONS

This application claims priority to U.S. patent application Ser. No. 16/292,261, for EVENT CONTENT DELIVERY, filed on Mar. 4, 2019, and U.S. Patent Application No. 62/818,086 for MEDIA CONTENT CAPTURE AND PRESENTATION, filed on Mar. 13, 2019. The disclosure of the foregoing applications are incorporated here by reference.

### BACKGROUND

This specification relates to social messaging platforms, and in particular, to providing event-specific media content to one or more users of the social messaging platform.

Conventional social messaging platforms allow users to maintain social networking profiles and build connections with other users. Social messaging platforms include common features that allow users to post messages, view messages, or comment on messages.

### SUMMARY

This specification describes technologies for composing messages associated with media content and providing those messages to one or more users of a social messaging platform. When a user of a social messaging platform composes a message to be sent to the platform using a mobile device, the social messaging platform can determine a location of the mobile device. Using the location of the mobile device, the social messaging platform can determine one or more topics corresponding to events that are occurring in the proximity of the location. If the user's message relates to a nearby event, e.g., includes text or media that describes the event, then the system can suggest one or more topics that correspond to the event for inclusion. Other users of the social messaging platform can search for content related to corresponding events by topic. In some implementations, the message can further include information that identifies a third-party to which the authoring account of the message is affiliated. This information allows a user of the platform to verify the authenticity of the authoring account, and therefore the authenticity of the corresponding message.

In general, one innovative aspect of the subject matter described in this specification can be embodied in methods that include the actions of receiving, by a social messaging platform, an indication of a message by a user of client software on a first user device; receiving, from the first user device, a first location of the first user device; providing, to the first user device, one or more topics that are specific to an event temporally associated with the first location; receiving, the message for posting on the social messaging platform, the message including (i) a topic selected from the one or more topics, and (ii) user selected media content; and adding the message to one or more streams of the social messaging platform.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Providing, to the first user device, one or more topics based, on the first location includes: receiving, from a second user device, a second topic associated with a second location; determining that the first location is within a threshold distance from the second location; and providing, to the first user device, the second topic associated with the second location. Providing, to the first user device, a topic of the one or more topics based on the first location includes: receiving, from the first user device, text related to the event as part of the message composition; generating a topic using the text and the first location; and providing, to the first user device, the generated topic.

The method further includes determining a location confidence score for the received location, wherein determining the first location confidence score includes determining whether the location was identified by user input or obtained directly from the user device, and wherein locations obtained directly from the user device have a greater confidence than locations identified by the user input; and determining whether to add the message to one or more streams based on the first location confidence score. The method further includes determining a content confidence score for the media content, wherein determining the content confidence score includes determining whether the media content is captured using an application associated with the social messaging platform; and determining whether to add the message to one or more streams based on the content confidence score.

The method further includes generating map data that identifies locations associated with one or more topics; and providing the map data for display on a user device. The method further includes in response to a request from a receiving user, retrieving stream content that includes the message; and providing the stream content for presentation, wherein the presentation includes the media content and a first overlay to the media content that provides one or more of a profile picture of the user, a name of the user, or a username of the user. The message presentation further includes a second overlay to the media content that presents one or more of text describing the media content, text identifying the first location, or text identifying a time that the message was posted by the user. The method further includes determining that the user is affiliated with a particular third-party organization; adding an overlay to the media content that identifies the third-party organization; in response to a request from a particular user device associated with a receiving user, retrieving stream content that includes the message and the overlay; and providing the stream content to the particular user device for presentation.

The subject matter described in this specification can be implemented in particular embodiments so as to realize one or more of the following advantages. The social messaging platform facilitates the dissemination of events as they occur. A user can construct, on the social messaging platform, a message that includes media content specific to a certain event. The user can post the media content as an event is occurring to allow other users to experience primary source information related to the event. The social messaging platform can also verify the location of the user, to provide confidence that the location in which the user captured the media content corresponds to the actual location in which the event is occurring. The social messaging platform can associate the media content with affiliated parties to provide further confidence in the source of the media content.

### BRIEF DESCRIPTION OF THE DRAWINGS

FIG. 1 is a block diagram of an example social messaging platform communicatively coupled with two user devices.

FIG. 2 is a flowchart of an example process for constructing a message using the social messaging platform of FIG. 1.

FIG. 3 is a flowchart of an example process for displaying broadcasts that are specific to the same event, but have different topics.

FIG. 4 shows an example interface presenting message content.

FIG. 5 shows an example interface presenting a message made by a third-party affiliated broadcaster.

FIG. 6 shows an example interface for capturing media content.

FIG. 7 shows an example interface for adding content to captured media.

FIG. 8 shows an example text composition interface.

FIG. 9 shows an example location selection interface.

FIG. 10 shows an example interface presenting a message composition.

FIG. 11 shows an example interface presenting a home timeline for a user account on the social messaging platform.

FIG. 12 shows an example interface presenting a selected message.

FIG. 13 shows an example interface presenting conversations associated with a selected message.

FIG. 14 shows an example interface for adding content to a live media stream.

FIG. 15 shows an example interface for capturing a live stream of media content.

Like reference numbers and designations in the various drawings indicate like elements.

### DETAILED DESCRIPTION

An online social messaging platform (“platform”) and user devices can interact over one or more data communication networks. The social messaging platform is implemented on one or more computers in one or more locations that operate as one or more servers that support connections over wired or wireless networks from many different kinds of user devices. The platform may have many millions of accounts, and anywhere from hundreds of thousands to millions of connections may be established or be in use between clients and the platform at any given moment.

The platform facilitates real-time communication. The platform and client software are configured to enable users to use the platform to post messages to the platform and to use the platform to receive messages posted by other users. In some implementations, the platform provides facilities for users to send messages directly to one or more other users of the platform, allowing the sender and recipients to maintain a private exchange of messages.

The platform is configured to provide content, generally messages, to a user in a message stream. The messages will generally be messages from accounts the user is following, meaning that the recipient has registered to receive messages posted by the followed account, and optionally content that such accounts have engaged with, e.g., endorsed. In some implementations, the platform is configured to include in a recipient user's message stream other messages that the platform determines are likely to be of interest to the recipient, e.g., messages on topics of particular current interest, as represented by the number of messages posted on the topics by users of the platform, or messages posted on the topics of apparent interest to the recipient, as represented by messages the recipient has posted or engaged with, as well as selected advertisements, public service announcements, promoted content, or the like.

The platform is configured to enable users to exchange messages in real-time, i.e., with a minimal delay. The platform is also configured to enable users to respond to messages posted earlier, on the order of hours or days or even longer. The platform is configured to display posted messages to one or more other users within a short time frame so as to facilitate what can essentially be a live conversation between the users.

Thus, the basic messaging functionality of the platform includes at least posting new messages, providing message streams for accounts in response to requests from corresponding users, managing accounts, managing connections between accounts, messages, and streams, and receiving engagement data from user accounts engaging with messages.

In some implementations of the platform, a message contains data representing content provided by the author of the message. The message may be a container data type storing the content data. The types of data that may be stored in a message include text, graphics, images, video, and computer code, e.g., uniform resource locators (URLs), for example. Messages can also include key phrases, e.g., hashtags that can aid in categorizing or relating messages to topics. Messages can also include metadata that may or may not be editable by the composing account holder, depending on the implementation. Examples of message metadata include a time and date of authorship and a geographical location of the user device when it submitted the message. In some implementations, what metadata is provided to the platform by a user device is determined by privacy settings controlled by the user or the account holder.

Messages composed by one account holder may reference other accounts, other messages, or both. For example, a message may be composed in reply to another message composed by another account holder. A message may also be composed by a user in reply to a message originally posted by the user. Messages may also be reposts of a message composed by and received from another account holder.

In some implementations, messages are microblog posts, which differ from e-mail messages, for example, in that an author of a microblog post does not necessarily need to specify, or even know, who the recipients of the message will be.

A stream is a stream of messages on the platform that meet one or more stream criteria. A stream can be defined by the stream criteria to include messages posted by one or more accounts. For example, the contents of a stream for a requesting account holder may include one or more of (i) messages composed by that account holder, (ii) messages composed by the other account holders that the requested account holder follows, (iii) messages authored by other account holders that reference the requested account holder, or (iv) messages sponsored by third-parties for inclusion in the account holder's message stream. The messages of a stream may be ordered chronologically by time and date of authorship, or reverse chronologically. Streams may also be ordered in other ways, e.g., according to a computationally predicted relevance to the account holder, or according to some combination of time and relevance score.

A stream may potentially include a large number of messages. For both processing efficiency and the requesting account holder's viewing convenience, the platform generally identifies a subset of messages meeting the stream criteria to send to a requesting client once the stream is generated. The remainder of the messages in the stream are maintained in a stream repository and can be accessed upon client request.

In general, account holders have relationships with other account holders on the platform. Relationships between account holders of the platform are represented by connection data maintained by the platform, e.g., in the form of data representing one or more connection graphs. The connection data may be maintained in a connection repository. A connection graph includes nodes representing accounts of the platform and edges connecting the nodes according to the respective relationships between the entities represented by the nodes. A relationship may be any kind of association between account holders, e.g., a following, friending, subscribing, tracking, liking, tagging, or other relationship. The edges of the connection graph may be directed or undirected based on the type of relationship.

In some implementations, the platform tracks engagement with messages. In some implementations, the platform maintains, in a message repository, data that describes each message as well as the engagement data with each message.

Engagement data can include any type of information describing user activity related to a message by an engaging account of the platform. Examples of engagement by a user include, for example, reposting the message, marking the message to indicate it is a favorite of, liked by, or endorsed by the user, responding to the message, and mentioning or referencing the message. Engagement data may also include how many followers, connections, and/or friends of the context account have connections with the engaging account, e.g., are in a connection graph of the engaging account, or an indication that the context account is a favorite account of the engaging account.

A user may be an account holder of an account, or an authorized user of an account on the platform. The platform may have millions of accounts of individuals, businesses, or other entities, e.g., pseudonym accounts, novelty accounts, and so on.

Users can interact with the social messaging platform through their respective user devices. A user device can be any suitable Internet-connected device, e.g., a laptop or desktop computer, a smartphone, or an electronic tablet. The user device can be connected to the Internet through a mobile network, through an Internet service provider (ISP), or otherwise.

Each user device is configured with software, which will be referred to as a client or as client software, that in operation can access the platform so that a user can post and receive messages, view and curate the user's streams, and view and interact with lists of content items. On any particular user device, the client may be a web browser or an HTML (hypertext markup language) document rendered by a web browser. Or the client may be or include JavaScript code or Java code. Or the client may also be dedicated software, e.g., an installed app or installed application, designed to work specifically with the platform. Or the client may be or include a Short Messaging Service (SMS) interface, an instant messaging interface, an e-mail-based interface, or an API function-based interface, for example. Data, e.g., messages, sent to the social messaging platform by a user device is sent to the platform by the client software on the user device. Similarly, data, e.g., one or more messages from a stream associated with the user, received by the user device from the social messaging platform, is received by the client software on the user device.

The social messaging platform can allow users to post text to a large number of other users to disseminate current events. Because many individuals are used to viewing media content on social messaging platforms, allowing a user to broadcast media content related to current events can be more engaging for both the broadcasting user and the users that view the broadcasted media content. In addition, the social messaging platform that can verify that a user is indeed at a location where breaking news is occurring can facilitate the dissemination of news-related media content that other users can trust to be authentic primary-source content. This specification describes techniques for associating media content related to a current event with one or more topics that describe the event, to provide users with trustworthy event coverage.

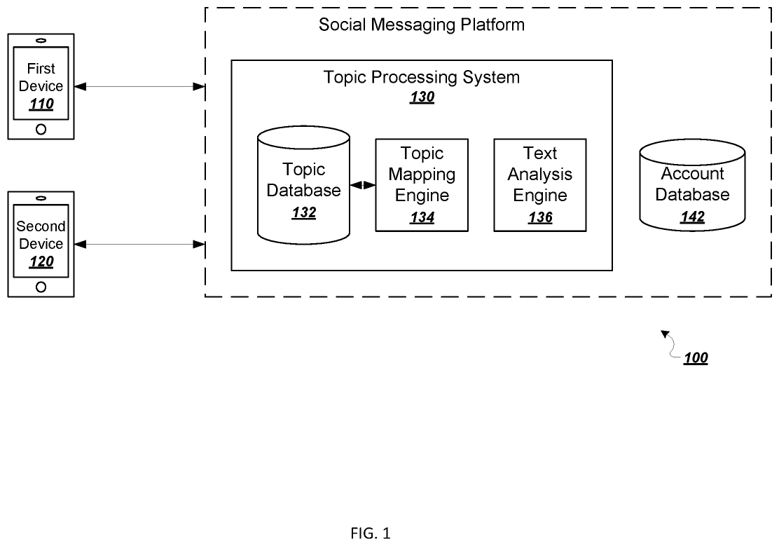

FIG. 1 is a block diagram of an example social messaging platform 100 communicatively coupled with user devices represented by a first device 110 and a second device 120. The social messaging platform 100 includes a topic processing system 130, which includes a topic database 132, a topic mapping engine 134, and a text analysis engine 136. The social messaging platform 100 also includes an account database 142. Arrows that connect the components of FIG. 1 denote communicative couplings between components.

In this specification the term “engine” is used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Various components of the topic processing system 130 can be located on the same device, e.g., a server, mainframe, or other suitable computing device, or can be located on separate devices connected by a network, e.g., a local area network (LAN), or the Internet.

A user device, for example the first device 110 or second device 120, can capture media content related to an event while at a particular location. Captured media content can include, for example, a photo, a video, an audio recording, or a GIF (Graphics Interchange Format). An event can be any particular activity or occasion occurring at a given location and time locally or globally. For example an event can be a holiday or other special occasion, a sporting event, a concert, a festival, a conference, a march, a rally, or a protest. As another example, an event can be a local or global news event such as a traffic jam, a power outage, or a wildfire.

The topic database 132 can maintain a mapping of event location to topics. A topic can be a word or phrase that describes an event. The topic processing system 130 can populate the topic database 132 based on upcoming events. For example, the topic processing system 130 can access a website that lists the dates, times, and locations of upcoming events, and generate one or more topics based on the upcoming events. As another example, the topic processing system 130 can access one or more news outlets, determine current or upcoming events, e.g., by parsing online news content sources, and generate one or more topics based on the current or upcoming events. The topic processing system 130 can also populate the topic database 132 based on topics provided to the social messaging platform 100 by one or more users.

Apart from populating the topic database 132 by collecting topic information from various sources as described above, topics can be identified from content posted by users to the social messaging platform. For example, if several users include similar content in posts associated with a given location, it may indicate a trending topic associated with that location. In particular, users may tag particular text, for example, with a hashtag that indicates its importance. When a threshold number of users post the same or similar text, it can indicate an event occurring at that location. The topic processing system 130 can store these topics derived from user message posts in the topic database 132.

For example, if a user encounters a wildfire, the user can document the wildfire by taking a video. The user can associate the video with a topic such as the text “#SonomaWildfire”. In addition to associating the media content with a topic, the user can also send text that elaborates on the event to the topic processing system 130. For example, the text can be, “Beware: wildfire sighting near Highway 12 and Calistoga Road.”

A user device can send a device location, e.g., as identified by the user device from a global positioning system (GPS) or other location system, the media content, the topic, and the text to the social messaging platform 100. In some implementations, the social messaging platform 100 can use the topic processing system 130 to perform one or more actions to determine whether the topic provided by the device is accurate.

If the text provided by the user includes a location, the topic processing system 130 can verify that the location specified by the topic corresponds to the device location. The topic processing system 100 can verify the location to ensure that topics are accurate, making the system less susceptible to malicious users that may attempt to broadcast an event that they are not actually in proximity to.

The topic processing system 130 can also send the topic to the text analysis engine 136. The text analysis engine 136 can analyze the text and verify that the topic does not contain any misspelled words and, if the topic does contain one or more misspelled words, then the text analysis engine 136 can suggest possible correct spellings of the one or more misspelled words. After determining that the topic is accurate, the topic processing system 130 can store the topic in the topic database 132.

The text analysis engine 136 can also determine whether the text that elaborates on the event includes a location. If the text includes a location, the text analysis can verify that the location corresponds to the first location. For example, if the text reads, “Very windy here at Point Reyes!” the text analysis engine can detect that the text includes a user-specified location, i.e., Point Reyes, and determine whether the location associated with the user device is within a threshold proximity of the user-specified location.

The account database 142 can maintain various relationships between accounts of the messaging platform or between accounts of the social messaging platform and other third parties. For example, some accounts may be identified as affiliated with a particular entity account. Some message posts, as described in greater detail below, can include an indication of the affiliated entity based on the relationships identified in the account database 142.

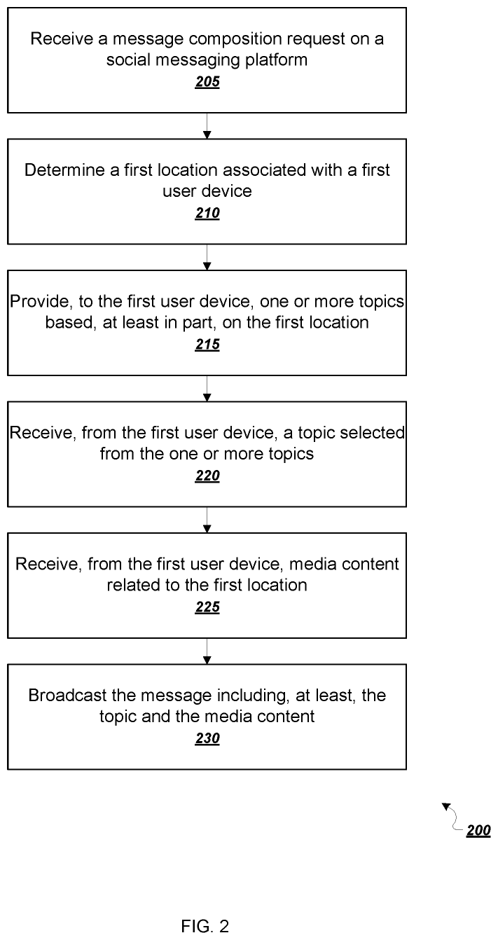

FIG. 2 is a flowchart of an example process 200 for composing a message using a social messaging platform. For convenience, the process 200 will be described as being performed by a system of one or more computers, located in one or more locations, and programmed appropriately in accordance with this specification. For example, a social messaging platform, e.g., the social messaging platform 100 of FIG. 1, properly programmed, can perform the process 200.

The social messaging platform receives a message composition request (205). The message composition request can be an indication that the user wants to post a message. When a user launches a messaging function on a user interface of the social messaging platform, the user's device can also send an indication of a message composition to the social messaging platform.

The social messaging platform determines a first location associated with a first user device (210). After determining the first location, the first user device can communicate the first location to a topic processing system of the social messaging platform. The first user device can use a number of ways to determine a location. For example, the first user device can use GPS location information to determine the first location. The social messaging platform can obtain the GPS information from the first user device. For example, the user can compose a message using a mobile application for the social messaging platform installed on the first user device. This application can request access to the GPS information of the first user device, for example, using an appropriate application programming interface. Similarly, when composing a message using a web browser on the first user device, the social messaging platform may be able to request access, through the browser, to the GPS information.

In some implementations, when the social messaging platform determines a location using one or more methods, the platform calculates a confidence score to the location. The confidence score can reflect the degree to which the social messaging platform trusts the authenticity of the location. For example, if the social messaging platform determines a location using the GPS location information obtained directly from the user device, the confidence score that the social messaging platform assigns to the GPS location information can be higher than the confidence score assigned to a location identified from the user's composed message text.

The social messaging platform can use the calculated confidence scores to select which messages are most relevant to certain topics or events. For example, the social messaging platform can collect and provide a collection of messages about a particular topic or event to a broader audience of users of the social messaging platform, e.g., in response to a user search query. In another example, the social messaging platform can provide media content related to a topic or event to users of the social messaging platform, e.g., including users of the social messaging platform that do not have a relationship with one or more of the authors of the collection of messages, for example by adding the content to a stream associated with respective user account. The message can be retrieved and presented when one of the user accounts requests content from their message stream.

The selection of messages of the collection of messages about the topic to provide to a given user account can be based on filter criteria such as whether the messages have a confidence score that satisfies a threshold value. Thus, a particular message can be included if the confidence score for that message satisfies the threshold. As another example, the social messaging platform can display messages associated with the topic in order of the confidence scores. Following this example, if the social messaging platform displays media content in a list, the platform can display the media content associated with high confidence scores towards the beginning of the list and media content with low confidence scores towards the end of the list. In some implementations, the confidence scores can be one or multiple ranking criteria that are combined to determine a final selection and ordering of messages.

Returning to the message composition of FIG. 2, the social messaging platform provides, to the first user device, one or more topics based, at least in part, on the first location, wherein the one or more topic can be specific to an event associated with at least the first location (215). The social messaging platform can provide the one or more topics using the user interface of the social messaging platform. For example, the user interface can display a popup or overlay that appears over or near a messaging window that a user of the social messaging platform uses to compose a message.

The platform can first determine whether there is a temporal association between the event and the location before determining topics based on the location to provide to the user device. A temporal association to an event indicates a time constraint between a location and an event occurring at the location. For example, an event is temporally associated with a location when the event is ongoing at the location, recently completed at the location, or occurring soon at the location.

For example, a concert that is occurring at a stadium represents an event, i.e., the concert, that is temporally associated with a location, i.e., the stadium. Accordingly, a user may want to view topics corresponding to the event that is occurring at the location. Likewise, a user at the location may post messages that include topics corresponding to the event.

By contrast, a concert that will occur at a stadium in the future or one that occurred at the stadium in the past may not be temporally associated with the stadium if the concert will not or has not occurred within a certain time range. This prevents an event from being incorrectly associated with a location with regard to determining one or more topics to provide to a user device.

For example, a stadium may host two separate concerts on two consecutive days, day 1 and day 2. Because the concerts are separate from each other, the social messaging platform recognizes each one as a separate event. Event 1 may be the concert occurring on day 1, while event 2 may be the concert occurring on day 2. Event 1 is temporally associated with the stadium during day 1. Event 2 is temporally associated with the stadium on day 2. Consequently, the temporal association is used to determine whether to suggest a topic for event 1 or event 2.

The components of the social messaging platform can use a number of methods to determine the one or more topics to provide.

In some implementations, the topic processing system determines the one or more topics based on a second location associated with a topic sent to the social messaging platform. Prior to determining the first location, the social messaging platform can receive, from a second user device, a topic associated with a second location. The social messaging platform can store the topic associated with the second location in a topic database. The topic processing system can then determine a threshold distance from the first location. The topic processing system can identify one or more topics associated with a location that satisfies the threshold distance from the first location. For example, the topic processing system can query the topic database to retrieve one or more topics that are within a threshold distance from the first location. As a result of querying the topic database, the topic processing system can retrieve a topic associated with a second location, which the topic processing system has determined is within the threshold distance from the first location. The topic processing system can then provide, to the first user device, the topic associated with the second location.

The threshold distance can be any distance that indicates two events are likely related by proximity. For example, the threshold distance can be an eighth of a mile, a quarter of a mile, a half a mile, or one mile. The threshold distance can be based on a coordinate distance or based on a relationship to a particular entity, e.g., within the same neighborhood, city, or region.

In the implementation described above, the topic processing system determines that media content captured at locations that satisfy the threshold distance relative to each other are likely to describe the same event; therefore, the topic processing system associates the media content with the same topic. For example, a first user can be at a first location, e.g., the first hole of a golf course for the Bay Area Golf Tour. Prior to receiving the first location, the topic processing system can also have received, from a second user at a second location, e.g., the parking lot of the Bay Area Golf Tour, media content that the second user associated with the topic “#BayAreaGolfTour”. The topic processing system can determine that the first location is within the threshold distance from the second location and that media content captured at the first location is likely to be associated with the topic “#BayAreaGolfTour” as well. In this way, the topic database can maintain a single topic for an event, regardless of whether the event is associated with multiple locations.

In some implementations, the topic processing system provides the one or more topics based on text related to a message. The text analysis engine 136 can process text related to a message and generate a topic based on the text. For example, in response to receiving the text “Hour long delay on the 101!” from a first user, the text analysis engine can generate a topic relevant to the text, e.g., “#TrafficJamOn101”, and add the generated topic to a topic database. The topic processing system can provide the generated topic to the first user device, so that the first user can associate the text with the generated topic. The topic processing system can also provide the generated topic to a second user based on text received from the second user, or the second user's proximity to the first user.

The social messaging platform receives, from the first user device, a topic selected from the one or more topics (220). The user selects a topic and sends the selection to the social messaging platform. Alternatively, the selected topic is sent to the social messaging platform with the completed message composition.

The social messaging platform receives, from the first user device, media content related to the first location (225). After capturing media content related to the first location, e.g., using the camera of the first user device, the user can also send the media content to the social messaging platform.

The media content related to the first location can be captured using a media application and hardware of the first user device, e.g., camera hardware and associated application software. For example, a mobile device can include an integrated camera that is configured to capture images or video content in response to user commands input to a user interface of the camera application. In some implementations, the camera hardware can be accessed by other applications of the user device, for example, an application associated with the social messaging platform. For example, as part of a message composition, a user may be able to select a command to capture media content to include in the message.

The social messaging platform can assign a confidence score to the media content based, for example, on the source of the media content. The confidence score can reflect the degree to which the social messaging platform trusts the authenticity of the media content. The social messaging platform can assign a high confidence score to media content captured using the user interface of the social messaging platform, and media content captured at the time and place of an event. A higher confidence score can indicate that the media content is more trustworthy than, for example, media content captured using the media application of the first user device independently from composition using the social messaging platform.

The social messaging platform posts the message including, at least, the topic and the media content (230). The social messaging platform can send the message to one or more other users depending on the message sharing settings of the first user.

In some alternative implementations, the message composition request is initiated by a user input to capture media content. For example, a user can provide a media capture request, which can then become part of a message to be posted to the social messaging platform, directly from a home timeline interface. The media capture request can be based on a user selection of a graphical element of the user interface or can be based on a user touch gesture. In some implementations, a user swiping motion to a touch interface presenting the home timeline interface can initiate a media capture by, e.g., a camera function. The camera function is configured to capture media in various formats including photos, video, and a live stream.

Although the media capture is initiated first, the actions of FIG. 2 can be similarly performed as described above. In particular, the user location and textual content can be obtained by the social messaging platform during or after media capture and topics can be similarly suggested to the user.

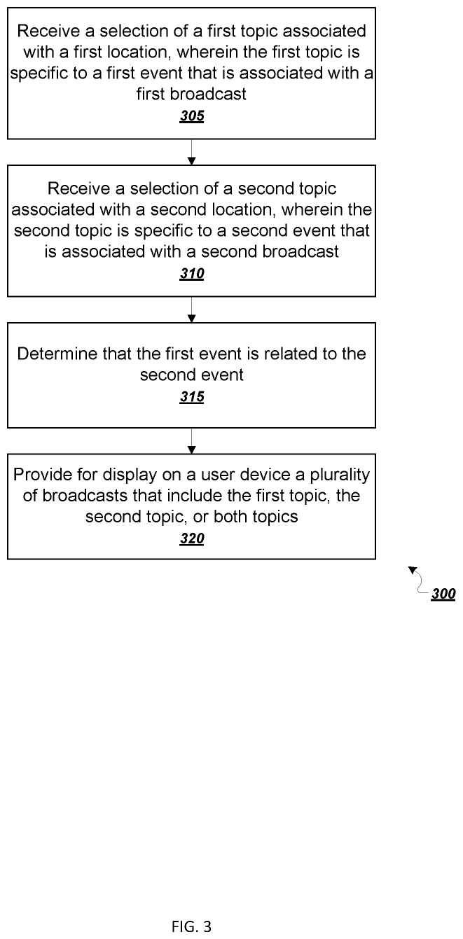

FIG. 3 is a flowchart of an example process 300 for displaying messages that are specific to the same event, but have different topics. For convenience, the process 300 will be described as being performed by a system of one or more computers, located in one or more locations, and programmed appropriately in accordance with this specification. For example, a social messaging platform, e.g., the social messaging platform 100 of FIG. 1, appropriately programed, can perform the process 300.

The social messaging platform receives a selection of a first topic associated with a first location, wherein the first topic is specific to a first event that is associated with a first message (305). The selection can be received, for example, in response to a message composition, submitted by a user account, as described above with respect to FIG. 2.

The social messaging platform receives a selection of a second topic associated with a second location, wherein the second topic is specific to a second event that is associated with a second message (310). The selection can be received, for example, in response to a message composition, submitted by a different user account, as described above with respect to FIG. 2.

The social messaging platform determines that the first event is related to the second event (315). A topic processing engine of the social messaging platform can determine that the first event and the second event are related in a number of different ways, as described in the following example implementations.

In some implementations, the social messaging platform determines that the first event is related to the second event by first determining that the first location is within a threshold distance from the second location. That is, the social messaging platform can determine the first and second events are related by virtue of their proximity.

In some other implementations, the social messaging platform determines that the first and second events are related by analyzing text received from respective message compositions. The social messaging platform can receive text associated with the second message. For example, the text can be sent to the social messaging platform by a user. The social messaging platform can then determine that the text is related to the first topic. In this implementation, a text analysis engine can process the text to determine that the text is related to the first topic. For example, the first and second topics can be “#MusicFestDay1” and “#MusicFestDay2”, respectively, while the text associated with the second broadcast can be “So excited for day 2 of Music Fest!” Although the two topics are not identical, the text analysis engine can process the text associated with the second broadcast to determine that the text is related to the first topic, e.g., that the text is related to a continuation of Music Fest Day 1, and that both topics describe the same, or similar, event, namely Music Fest.

In another implementation, the social messaging platform determines that the first event is related to the second event by receiving, from a user device, an indication that the first topic is related to the second topic. If the user interacts with a topic, e.g., by tapping or clicking on the topic, the interface of the social messaging platform can present a dialog box that allows the user to provide related topics. For example, a user could construct a message that includes the topic “#MusicFestDay1”. The user can then provide the topic “#MusicFestDay2” as a related topic.

The social messaging platform provides for display on a user device content including one or more message posts that include the first topic, the second topic, or both topics (320). For example, the social messaging platform can provide the messages in response to a user search for content associated with the first or second topic. Because the first and second events are related, a user may want messages associated with the events to be displayed contiguously, regardless of whether the messages share the same topic. For example, a user may want to view messages related to Music Fest, regardless of whether those messages include the same topic.

A first user can choose an event and view messages related to the chosen event, including multiple topics related to the event. In some implementations, the set of messages related to the chosen event can include messages created by users that the first user does not have a relationship with.

In some implementations, the social messaging platform generates a user interface that presents a map that shows locations associated with one or more topics. The topic processing system can include a topic mapping engine that is configured to access the topic database to retrieve the locations that are present in the database. The topic mapping engine 134 can generate a map that includes the locations retrieved from the database along with one or more topics associated with each location. The social messaging platform can send the map to a user device, which can display the map on a user interface. In some implementations, a user can specify an event to the social messaging platform, which can then display the location of the event and topics associated with the event using the map. A user can interact with the map to view content specific to an event, e.g., messages or media content about the event.

In some implementations, additional information can be added to a message being composed. For example, a composing user can provide additional details about the video or image content that has been captured for inclusion in the message. Rather than appending this content as a separate text portion of the message, the system can overlay this information in a region of the media content similar to a television chyron. In some other implementations, other information identifying the source of the post is laid over the content, for example, an identifier of the composing user or an identifier of an entity or organization associated with the composing user.

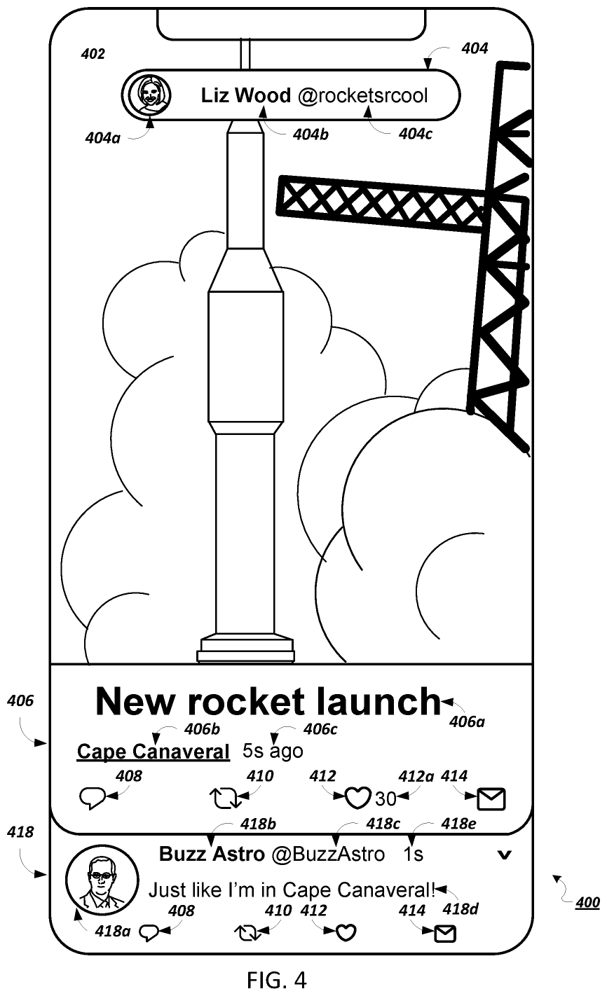

FIG. 4 shows an example interface 400 that is displayed on a user device. In this implementation, an application running on the user device, e.g., an application for the social messaging platform, can display the interface 400, which the user of the device, the viewing user, can view and interact with. For example, if the user device includes a touch-sensitive display, the viewing user can interact with the application by touching the display of the device. The interface 400 can represent a response to the viewing user's selection of a message presented on a message feed of the user.

Another user, referred to as a composing user, composed a message based on capturing a photo 402 or video to post to the social messaging platform, using techniques similar to those described above. Interface 400 shows a view that the viewing user of the user device sees when viewing the photo 402, which in this example shows the launch of a rocket.

Interface 400 includes additional overlay information. For example, the interface 400 includes a first overlay 404 that provides information about the composing user. The first overlay 404 includes a profile picture 404a, a name 404b, and a username 404c. The information about the composing user can be retrieved from a user profile of the composing user.

In addition to sending the photo 402 to the social messaging platform 100, the system can add text describing the photo and a location at which the photo was taken for presentation in a second overlay. In FIG. 4, the second overlay 406 includes user submitted text 406a. Also displayed in the second overlay 406 is a location 406b corresponding to the location that the photo 402 was taken and a timestamp 406c, corresponding to the time at which the composing user sent the message to the social messaging platform. The composing user can specify the location, which can be verified by the system as described above with regard to determining confidence scores. If the composing user does not specify the location, it can be automatically added as part of the message composition by the composing user. In addition to automatically adding a location, the system can also automatically add a timestamp.

In addition to displaying text 406a, location 406b, and timestamp 406c, the second overlay 406 also includes graphical control buttons that the viewing user can use to interact with the social messaging platform. The second overlay 406 includes a reply button 408, a rebroadcast button 410, a like button 412, and a direct message button 414.

Using the reply button 408, the viewing user can view replies related to the message. For example, the replies can include text and media uploaded by other users of the social messaging platform. In addition, the reply button 408 can also allow the viewing user to post their own reply to the message.

The repost button 410 allows the viewing user to repost the message including the photo 402, the text 406a, and the location 406b. That is, the viewing user can repost the complete message so that the message is provided to the message feed of other users of the social messaging platform that follow the viewing user.

The like button 412 allows the viewing user to like the message. In some implementations, liking the message increments a counter that tracks the total number of likes the message has received. A count 412a shows the viewing user the total number of likes the message has.

The direct message button 414 allows the viewing user to respond directly to the broadcaster of a message, e.g., the composing user.

Alternatively, or additionally, an interface can include other graphical control buttons for performing different operations, e.g., sharing a message or saving it as a bookmark for later viewing. As another example, an interface can include a button that allows a viewing user to email or text a message to members of the user's contacts.

Interface 400 can show one or more replies made to the composing user by a user of the social messaging platform. In the example of FIG. 4, the viewing user replies to the composing user, e.g., using the reply button 408. Interface 400 shows a reply box 418, which displays the viewing user's reply text to the composing user as well as identification information of the viewing user. The identification information of the viewing user includes a profile picture 418a, a name 418b, and a username 418c. In addition to the identification information, the reply box 418 also displays reply text 418d and a timestamp 418e, which corresponds to the time that the viewing user sent the reply text to the social messaging platform. Like the second overlay 406, the reply box 418 also includes the graphical control buttons described above, namely, the reply button 408, the rebroadcast button 410, the like button 412, and the message button 414.

In the example of FIG. 4, the composing user is an individual who maintains their own private account on the social messaging platform, the account being unaffiliated with any third-party organizations. Other times, the composing user is affiliated with a third-party organization. For example, the composing user can be a spokesperson for a company, a faculty member from a university, or a reporter for a news outlet.

A third-party organization can have an account on the social messaging platform 100. When a composing user is affiliated with a third-party organization, the social messaging platform can determine the composing user's affiliation and display a graphic that indicates the determined affiliation. For example, the social messaging platform can access a third-party account database, e.g., the third-party account database 142 of FIG. 1, to determine an affiliation of the composing user's account. Similarly, the social messaging platform can access a third-party graphics database, e.g., the third-party graphics database 144 of FIG. 1, to determine a graphic unique to a third-party.

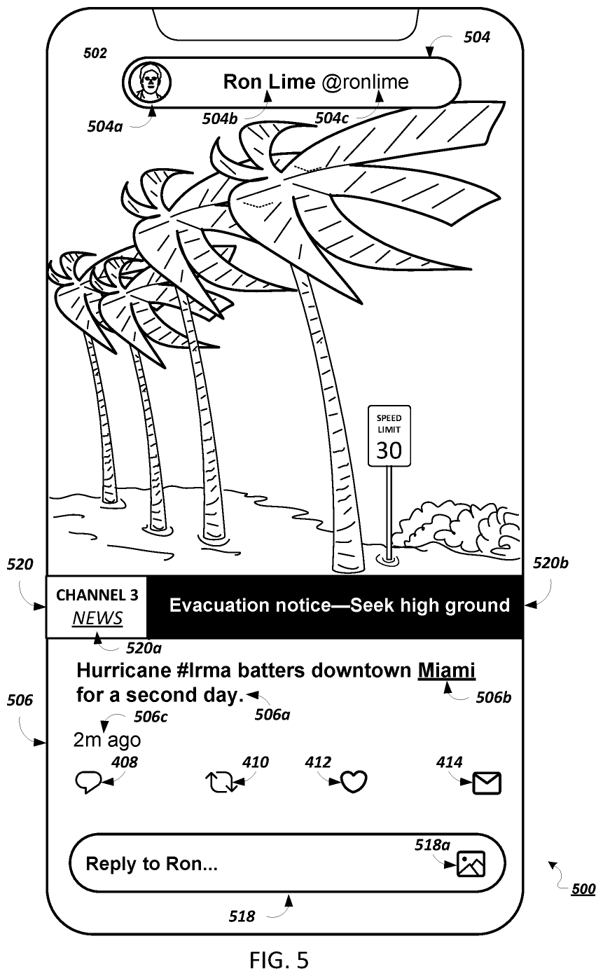

FIG. 5 shows an example interface 500 that includes a message made by a composing user that is affiliated with a third-party organization. Just as interface 400 shows a view that would be seen by the user of the user device viewing the posted message, interface 500 is also a view that would be seen by the viewing user.

The third-party broadcaster sends a photo 502 to the social messaging platform. As illustrated by interface 500, the photo 502 relates to a weather report and shows an image of Hurricane Irma.

Similar to interface 400, interface 500 displays the photo 502 along with first overlay 504, which displays identification information of the third-party composing user, e.g., a profile picture 504a, a name 504b, and a username 504c. Interface 500 includes a second overlay 506, which displays text 506a, sent to the social messaging platform 100 by the third-party composing user. The text 506a describes the photo 502 and includes the topic “#Irma”. Second overlay 506 also includes a location 506b and a timestamp 506c. Also like interface 400, interface 500 includes the reply button 408, the rebroadcast button 410, the like button 412, and the message button 414.

Although interface 400 shows the reply box 418, interface 500 does not show a reply box, indicating that the neither the viewing user, nor any other user of the social messaging platform, has sent a reply to the third-party composing user. Because no user has a reply, interface 500 shows a reply bubble 518. Using the reply bubble 518, the viewing user can reply directly to the third-party composing user. The reply bubble 518 also includes media button 518a, which allows the viewing user to attach media, e.g., pictures or videos, to the reply.

As mentioned above, the composing user described with regard to interface 500 is affiliated with a third-party organization. In the example of FIG. 5, the third-party is a news outlet and the composing user is a reporter for the news outlet. The social messaging platform detects the affiliation and displays overlay 520, which shows a logo 520a of the news outlet similar to a television chron. In addition to displaying the logo 520a, the overlay 520 also shows text 520b. The text 520b can be generated by an account administrator for the third-party account. Because the third-party is a news outlet, the text 520b displays a headline from the news outlet.

In some implementations, the overlay can show additional information based on a particular event. For example, when an interface is displaying text and media related to a sporting event, a chyron can show a score of the sporting event.

Therefore, the social messaging platform verifies the identity of the third-party composing user and provides the overlay 520 as an indication of the composing user's verified identity. This is advantageous for a user of the social messaging platform because the user is able to verify the authenticity of the message based on the verified identity of the third-party composing user.

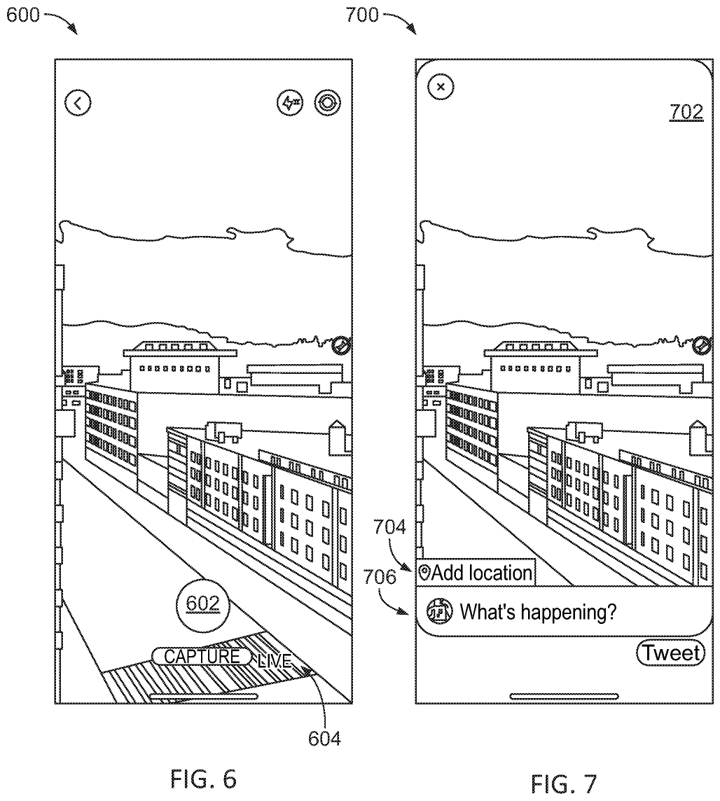

FIG. 6 shows an example interface 600 for capturing media content. In some implementations, the interface 600 corresponds to a camera function of a client application associated with the social messaging platform. As described above, the camera function can be accessed through one or more graphical user interface elements, e.g., within a home timeline interface or a message composition interface. Additionally, in some implementations, the camera function is accessed through a touch gesture, e.g., a directional swipe.

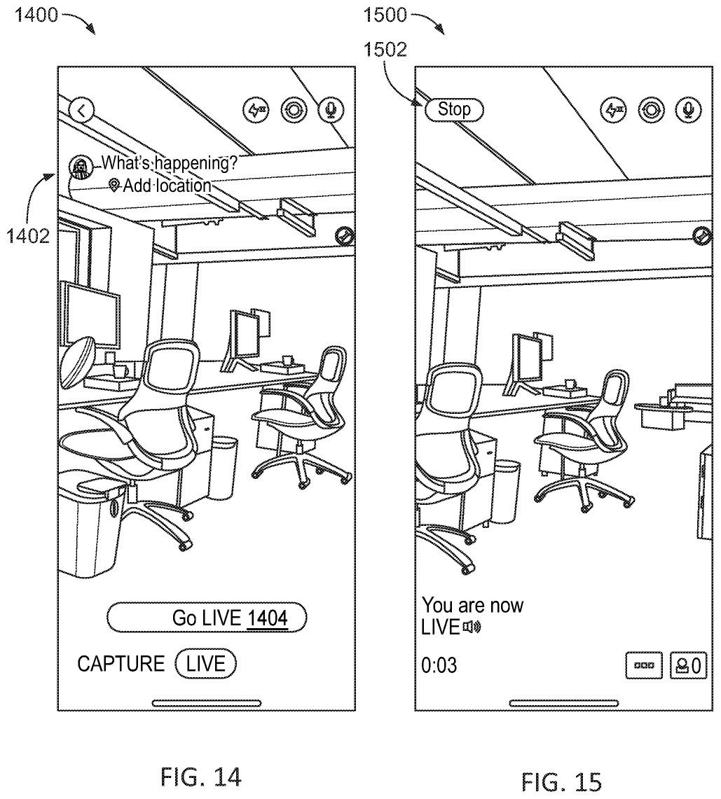

The interface 600 illustrates the camera functions including a display of the current field of view of the camera hardware of the user device and a capture touch element 602. In particular, the touch element 602 can be used to capture both still photos and video content. For example, a touch and release to the touch element 602 can capture a single photo while a long press can capture video content for as long as touch contact is maintained with the touch element 602. A live element 604 provides another way to capture video content as a live stream, as will be described below with respect to FIGS. 14-15.

FIG. 7 shows an example interface 700 for adding content to captured media as part of a message composition for posting to the social messaging platform. The captured media can be an image 702 captured, e.g., using the camera functionality shown in FIG. 6. After capturing the media content, the interface 700 can present options for adding content including a location element 704 for adding a location and a text composition element 706 for adding text. A posting element 708 allows the user to post the message to the social messaging platform, e.g., to one or more message streams of user accounts, with or without the added content.

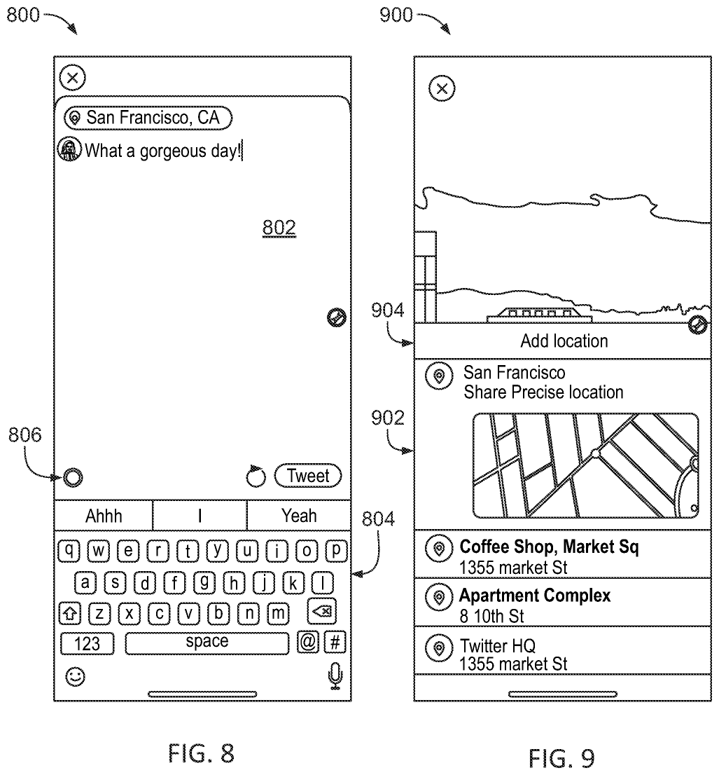

FIG. 8 shows an example text composition interface 800. The text composition interface 800 is presented, for example, in response to a user selection of the text composition element 706 of FIG. 7. The text composition interface 800 is presented as an overlay to the media content and includes a text input portion 802 and a keyboard 804. The user, for example, can describe the media content or input other text, including graphical elements such as emoji's, to include as part of a message to post on the social media platform.

In some implementations, this text content is incorporated into an overlay to the media content rather than a separate text portion of the message, e.g., above or below the media content of the message. As part of an overlay, the user can select a background color for the overlay using a color selection element 806. Upon selection, the user interface can be modified to present a group of colors available for selection. In some alternative implementations, further customizations can be selected including text color and style.

FIG. 9 shows an example location selection interface 900. The location selection interface 900 is presented, for example, in response to a user selection of the location element 704 of FIG. 7. The location selection interface 900 presents candidate location selections 902. The listed candidate location selections are presented based on the location of the user device. For example, as described above, the social messaging platform can obtain location data from the user device, e.g., GPS or WiFi data. This location data can be used to identify entities nearby the location as candidate locations. In some implementations, additional candidate entities can be viewed by scrolling through the candidate location selections 902. Furthermore, a user can specify the location directly using an add location element 904. In some implementations, the candidate location selections 902 include a map of the local area indicating the detected location of the user device.

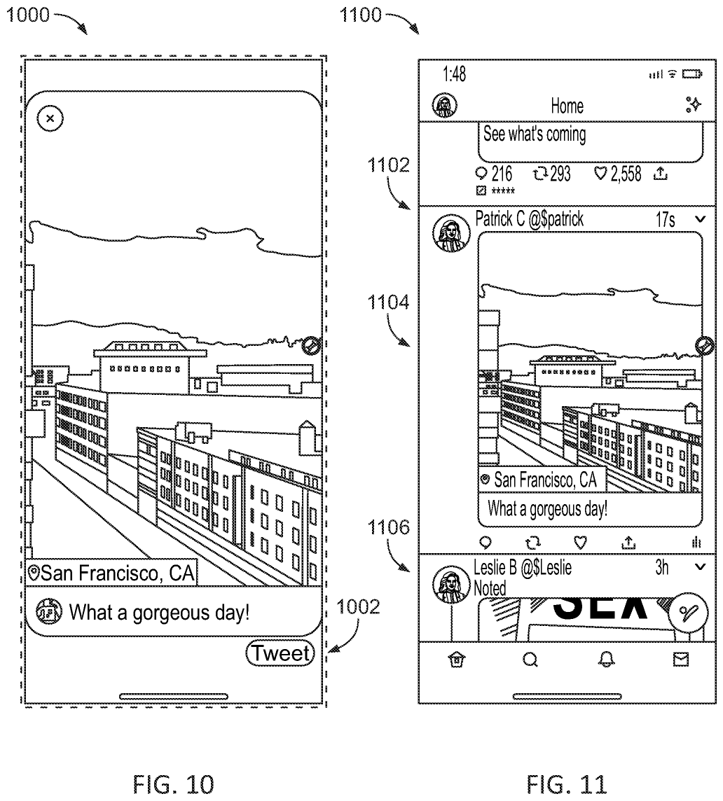

FIG. 10 shows an example interface presenting a composed message 1000 for posting to a social messaging platform. For example, after specifying a location and adding text, the composed message 1000 can provide a preview of the message prior to posting to the social messaging platform. The composed message 1000 includes the overlay to the media content indicating the location and the specified text. The user can post the message to the social messaging platform using a graphical element 1002. The posted message is added by the social messaging platform to one or more message feeds of other user accounts of the social messaging platform. For example, to message feeds corresponding to user accounts that have a follow relationship with the posting account.

FIG. 11 shows an example interface 1100 presenting a home timeline 1102 for a user account on the social messaging platform. The home timeline 1102 can be generated and presented on a user device, for example, by a client application associated with the social messaging platform. For example, a user having an account with the social messaging application can execute a corresponding client application.

The social messaging system selects messages from the user account's message stream and provides them for presentation on the client device in a home timeline. The messages of the home timeline can be ordered in different ways including in reverse chronological order or in a ranked order according to one or more ranking criteria.

In particular, the home timeline 1102 can belong to a follower of account that has posted a media content message 1104, e.g., the posted message 1000 of FIG. 10. In the home timeline 1102, the media content message 1104 is presented as a large representation of the media content with the overlay content. This is in contrast to other messages that can contain only text or that append media content that is not directly captured using the camera functionality. For example, messages that include media content that is not captured using the camera functionality as described above have a separate text content positioned above a smaller representation of the media content, for example, as partially shown by timeline message 1106.

In particular, in some implementations, the home timeline is designed to emphasize messages composed using the camera functionality by using a larger representation of the media content than other media content posted to the social messaging platform in other messages. Furthermore, since the text content is part of an overlay, the media content is more prominent than in messages where the media content is presented below text content of the message. Additionally, messages presented in user account timelines in this way can provide an indication that the message relates to content captured on location at the time of message composition rather than media content from some other source or time.

In some implementations, messages in the home timeline, including the media content message 1104, can be selected within the home timeline to view additional information associated with the message.

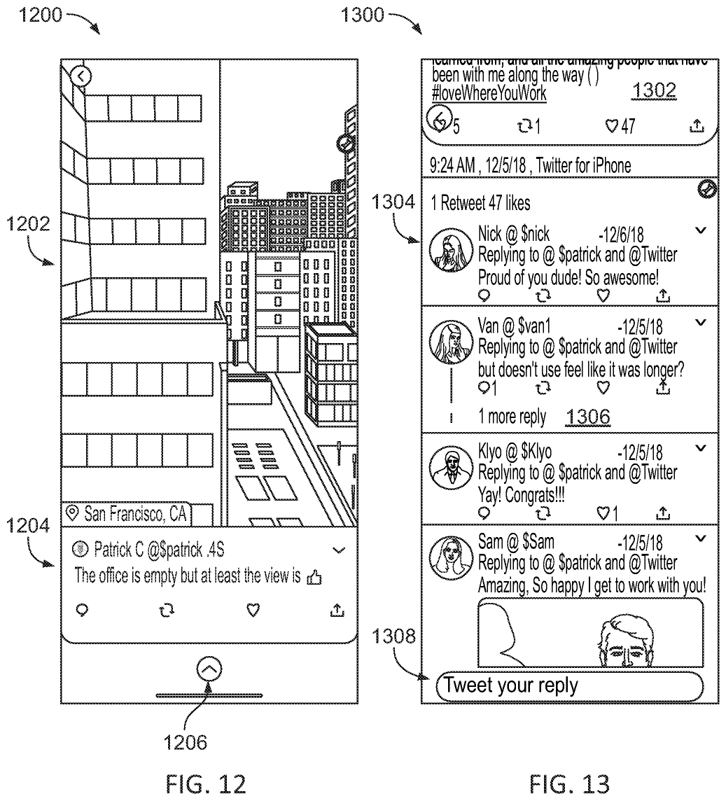

FIG. 12 shows an example interface 1200 presenting a selected media content message 1202. The media content message 1202 can be presented, for example, in response to a user selection of the message from a home timeline. The presented media content message includes the media content, e.g., photo, and an overlay portion 1204 that includes a location and user generated message content, e.g., text content about the media content.

The interface 1200 also includes a graphical element 1206. Upon selection of the graphical element 1206, additional content about the message can be presented, for example, replies to the message or conversations between different user accounts associated with a reply to the message. This allows the user to seamlessly transition from the content of the message to conversations about the message. In some implementations, selecting the graphical element 1206 is performed by a user touch gesture sliding up from the graphical element 1206.

FIG. 13 shows an example interface 1300 presenting conversations associated with a selected message. The interface 1300 includes a portion of the media content message 1302 and a conversation portion 1304. The conversation portion 1304 can be presented, for example, in response to a user slide gesture relative to a presented media content message. As a result, the interface can slide the media content message up in order to display the conversation portion 1304. In the example shown, a portion of the media content message 1302 remains visible in the interface and in some implementations a reverse gesture, e.g., a slide down, can return to the previous media content message display similar to that shown in FIG. 12. In some other implementations, a back element is used to return to the prior interface.

The conversation portion 1304 includes a number of replies to the media content message. In some instances, the replies are part of a longer conversation where user accounts reply to other replies rather than replying directly to the media content message. These conversations can be presented in a truncated fashion as shown with conversation 1306 and can be expanded in response to a user interaction, e.g., a selection associated with that conversation.

The conversation portion 1304 also includes a reply field 1308. The reply field 1308 allows the user to input and submit reply to the media content message. For example, in response to a user selection of the reply field 1308, a keyboard can be presented for inputting a reply. After entering content into the reply field 1308, an graphical element can be presented to post the reply to the media content message on the social messaging platform.

FIG. 14 shows an example interface 1400 for adding content to a live media stream. The interface 1400 can be presented, for example, in response to a user selection of a live element, e.g., live element 604 of FIG. 6. The interface 1400 allows the user to present a live stream that is posted to the social messaging platform. In preparation to go live, the use can first provide some additional information including adding content and a location. In particular, interface 1400 includes a display of a current field of view captured by the camera hardware of the user device. An overlay interface element 1402 allows the user to add content that will be presented with the live stream, for example, a text description of what is being live streamed. The user can also add a location at which the live stream is taking place. The text content and location can be added in a similar manner to that described above with respect to FIGS. 8 and 9. A “go live” user interface element 1404 allows the user to start the live stream which will concurrently be sent to the social messaging platform and added to one or more message streams.

FIG. 15 shows an example interface 1500 for capturing a live stream of media content. In particular, the interface 1500 shows the field of view being captured by the camera hardware, e.g., as a running video capture. When the user has finished the live stream, the user can select a stop element 1502 to end the live stream.

In some implementations, during the live stream, the corresponding home timelines presented to following users places the live stream at the top of the timeline of messages. After the live stream has ended, the live stream can be provided as a recording message positioned in user's timelines according to the sorting criteria used, e.g., reverse chronological order or ranked order.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a method comprising: receiving, by a social messaging platform, an indication of a message by a user of client software on a first user device; receiving, from the first user device, a first location of the first user device; providing, to the first user device, one or more topics that are specific to an event temporally associated with the first location; receiving, the message for posting on the social messaging platform, the message including (i) a topic selected from the one or more topics, and (ii) user selected media content; and adding the message to one or more streams of the social messaging platform.

Embodiment 2 is the method of claim 1, wherein providing, to the first user device, one or more topics based, on the first location comprises: receiving, from a second user device, a second topic associated with a second location; determining that the first location is within a threshold distance from the second location; and providing, to the first user device, the second topic associated with the second location.

Embodiment 3 is the method of any one of embodiments 1 or 2, wherein providing, to the first user device, a topic of the one or more topics based on the first location comprises: receiving, from the first user device, text related to the event as part of the message composition; generating a topic using the text and the first location; and providing, to the first user device, the generated topic.

Embodiment 4 is the method of any one of embodiments 1 through 3, further comprising: determining a location confidence score for the received location, wherein determining the first location confidence score includes determining whether the location was identified by user input or obtained directly from the user device, and wherein locations obtained directly from the user device have a greater confidence than locations identified by the user input; and determining whether to add the message to one or more streams based on the first location confidence score.

Embodiment 5 is the method of any one of embodiments 1 through 4, further comprising: determining a content confidence score for the media content, wherein determining the content confidence score includes determining whether the media content is captured using an application associated with the social messaging platform; and determining whether to add the message to one or more streams based on the content confidence score.

Embodiment 6 is the method of any one of embodiments 1 through 5, further comprising: generating map data that identifies locations associated with one or more topics; and providing the map data for display on a user device.

Embodiment 7 is the method of any one of embodiments 1 through 6, further comprising: in response to a request from a receiving user, retrieving stream content that includes the message; and providing the stream content for presentation, wherein the presentation includes the media content and a first overlay to the media content that provides one or more of a profile picture of the user, a name of the user, or a username of the user.

Embodiment 8 is the method of embodiment 7, wherein the message presentation further includes a second overlay to the media content that presents one or more of text describing the media content, text identifying the first location, or text identifying a time that the message was posted by the user.

Embodiment 9 is the method of any one of embodiments 1 through 8, further comprising: determining that the user is affiliated with a particular third-party organization; adding an overlay to the media content that identifies the third-party organization; in response to a request from a particular user device associated with a receiving user, retrieving stream content that includes the message and the overlay; and providing the stream content to the particular user device for presentation.

Embodiment 10 is a method comprising: obtaining, by a social messaging platform, event data, the event data identifying an event, a location of the event, a time of the event, and one or more topics associated with the event; receiving, by the platform, a plurality of messages from respective user devices, each message including respective media content and at least one topic of the one or more topics, wherein each message is associated with a respective origination location; generating, by the platform and for each of the plurality of messages, a plurality of respective confidence scores, each confidence score representing a distinct measure of confidence that the message comprises content captured at the event, the confidence scores including a media confidence score and a location confidence score, wherein the media confidence score for a message represents a measure of confidence that the media content in the message was recorded at the location and the time of the event and the location confidence score for a message represents a measure of confidence in the accuracy of a respective location associated with the message; receiving, by the platform, a request for content relating to the event; and providing, in a response to the request, a stream of responsive messages, wherein the responsive messages each include one or more of the at least one topics, wherein messages of the stream are provided in a ranked order according to a combination of the plurality of confidence scores.

Embodiment 11 is the method of embodiment 10, wherein the combination of the plurality of confidence scores is a weighted sum of the confidence scores.

Embodiment 12 is the method of embodiment 11, further comprising: obtaining the weights for the weighted sum of confidence scores from a machine learning model trained to generate to classify messages as including or not including content of respective events.

Embodiment 13 is the method of any one of embodiments 10 through 12, wherein generating a location confidence score for a message comprises: receiving a message location for the message, wherein the message location is a location where the message was authored on the user device or a location from which the message was sent to be received by the platform; and generating a location score that represents a measure of confidence in the accuracy of the message location.

Embodiment 14 is the method of any one of embodiments 10 through 13, wherein generating a location confidence score for a message comprises: determining whether device location information representing the location of the user device at the time the message was sent to the platform is available from the user device; in response to determining that the device location information is available, generating the location confidence score to represent a high measure of confidence; and otherwise, generating the respective location confidence score to represent a measure of confidence lower than had the device location information been available.

Embodiment 15 is the method of any one of embodiments 10 through 14, wherein generating the media confidence score for a message comprises: determining whether the media content in the message was captured using client software previously designated by the platform as trustworthy; in response to determining that the media content was captured using client software previously designated by the platform as trustworthy, generating the media confidence score to represent a high measure of confidence; and otherwise, generating the media confidence score to represent a measure of confidence lower than had the media content in the message been captured using the client software.

Embodiment 16 is the method of any one of embodiments 10 through 15, wherein generating a media confidence score for a message comprises: obtaining, from the message, content metadata defining a location at which the media content in the message was captured; determining that the location of the event and the location defined in the message content metadata are within a threshold distance of each other, and in response to determining that the location of the event the location defined in the message content metadata are within the threshold distance of each other, generating the media content confidence score to represent a high measure of confidence.

Embodiment 17 is the method of any one of embodiments 10 through 16, wherein generating a media confidence score for a message comprises: obtaining, from the message, content metadata representing a time at which the respective media content was captured; determining that a time at which the platform received the message and the time defined in the content metadata are within a threshold distance; and in response to determining that the time at which the platform received the message and the time defined in the content metadata are within the threshold distance, generating the respective content confidence score to represent a high measure of confidence.

Embodiment 18 is the method of any one of embodiments 10 through 17, wherein the plurality of confidence scores comprises a media similarity confidence score for each message that represents a measure of similarity between (i) the media content in the message and (ii) reference media content associated with the event.

Embodiment 19 is the method of embodiment 18 wherein generating a media similarity confidence score for a message comprises: obtaining from an authenticated source of event media content, authenticated reference media content associated with the event; and generating the media similarity confidence score for the message by determining a measure of similarity between the media content of the message and the authenticated media content.

Embodiment 20 is the method of any one of embodiments 18 or 19, wherein generating a media similarity confidence score for a message comprises: obtaining from the platform, other-user reference media content from messages sent to the platform during the event and associated by the platform with the event; and generating the media similarity confidence score for the message by determining a measure of similarity between the media content of the message and the other-user reference media content.

Embodiment 21 is the method of any one of embodiments 10 through 20, wherein the plurality of confidence scores comprises a message similarity confidence score for each message that represents a measure of similarity between (i) the message and (ii) reference messages associated with the event.

Embodiment 22 is the method of embodiment 21, wherein the reference messages comprise a message authored by an event account associated with the event.

Embodiment 23 is the method of any one of embodiments 21 or 22, wherein the reference messages comprise a message sent to the platform and comprising at least one topic of the one or more topics associated with the event.

Embodiment 24 is the method of any one of embodiments 10 through 23, wherein each of the one or more topics are topics previously recognized as topics by the platform.

Embodiment 25 is the method of any one of embodiments 10 through 24, wherein the one or more topics are each represented in the event data by a respective string of text.

Embodiment 26 is the method of any one of embodiments 10 through 25, wherein the at least one topic in each message of the plurality of messages is represented by a respective string of text in a body of the message.

Embodiment 27 is the method of any one of embodiments 10 through 26, wherein the at least one topic in each of the plurality of messages is represented by respective metadata in the message.

Embodiment 28 is the method of any one of embodiments 10 through 27, wherein the respective location of the user device is a location when the user device sent the message to the platform.

Embodiment 29 is the method of any one of embodiments 10 through 28, wherein the respective location of the user device associated with a message is a location when the user device included the media content in the message.

Embodiment 30 is the method of any one of embodiments 10 through 29, wherein the respective location of the user device associated with a message is a location of the user device when the user device authored the message.

Embodiment 31 is a computer program product, encoded on one or more non-transitory computer storage media, comprising instructions that, when executed by one or more computers, cause the one or more computers to perform the method of any one of embodiments 1 through 30.

Embodiment 32 is a system comprising: one or more user devices; and one or more computers configured to interact with the one or more user devices and to perform the method of any one of embodiments 1 through 30.

While this specification contains many specific implementation details, these should not be construed as limitations on the scope of what is disclosed or on the scope of what is being or may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining, by a social messaging platform, event data, the event data identifying an event, a location of the event, a time of the event, and one or more topics associated with the event;
receiving, by the platform, a plurality of messages from respective user devices, each message including respective media content and at least one topic of the one or more topics, wherein each message is associated with a respective origination location;
generating, by the platform and for each of the plurality of messages, a plurality of respective confidence scores, each confidence score representing a distinct measure of confidence that the message comprises content captured at the event, the confidence scores including a media confidence score and a location confidence score, wherein the media confidence score for a message represents a measure of confidence that the media content in the message was recorded at the location and the time of the event and the location confidence score for a message represents a measure of confidence in the accuracy of a respective location associated with the message;
receiving, by the platform, a request for content relating to the event; and
providing, in a response to the request, a stream of responsive messages, wherein the responsive messages each include one or more of the at least one topics, wherein messages of the stream are provided in a ranked order according to a combination of the plurality of confidence scores.

2. The method of claim 1, wherein the combination of the plurality of confidence scores is a weighted sum of the confidence scores.

3. The method of claim 2, further comprising:
obtaining the weights for the weighted sum of confidence scores from a machine learning model trained to generate to classify messages as including or not including content of respective events.

4. The method of claim 1, wherein generating a location confidence score for a message comprises:
receiving a message location for the message, wherein the message location is a location where the message was authored on the user device or a location from which the message was sent to be received by the platform; and
generating a location score that represents a measure of confidence in the accuracy of the message location.

5. The method of claim 1, wherein generating a location confidence score for a message comprises:
determining whether device location information representing the location of the user device at the time the message was sent to the platform is available from the user device;
in response to determining that the device location information is available, generating the location confidence score to represent a high measure of confidence; and
otherwise, generating the respective location confidence score to represent a measure of confidence lower than had the device location information been available.

6. The method of claim 1, wherein generating the media confidence score for a message comprises:
determining whether the media content in the message was captured using client software previously designated by the platform as trustworthy;
in response to determining that the media content was captured using client software previously designated by the platform as trustworthy, generating the media confidence score to represent a high measure of confidence; and
otherwise, generating the media confidence score to represent a measure of confidence lower than had the media content in the message been captured using the client software.

7. The method of claim 1, wherein the plurality of confidence scores comprises a media similarity confidence score for each message that represents a measure of similarity between (i) the media content in the message and (ii) reference media content associated with the event.

8. A system comprising:
one or more computers and one or more storage devices on which are stored instructions that are operable, when executed by the one or more computers, to cause the one or more computers to perform operations comprising:
obtaining, by a social messaging platform, event data, the event data identifying an event, a location of the event, a time of the event, and one or more topics associated with the event;
receiving, by the platform, a plurality of messages from respective user devices, each message including respective media content and at least one topic of the one or more topics, wherein each message is associated with a respective origination location;
generating, by the platform and for each of the plurality of messages, a plurality of respective confidence scores, each confidence score representing a distinct measure of confidence that the message comprises content captured at the event, the confidence scores including a media confidence score and a location confidence score, wherein the media confidence score for a message represents a measure of confidence that the media content in the message was recorded at the location and the time of the event and the location confidence score for a message represents a measure of confidence in the accuracy of a respective location associated with the message;
receiving, by the platform, a request for content relating to the event; and
providing, in a response to the request, a stream of responsive messages, wherein the responsive messages each include one or more of the at least one topics, wherein messages of the stream are provided in a ranked order according to a combination of the plurality of confidence scores.

9. The system of claim 8, wherein the combination of the plurality of confidence scores is a weighted sum of the confidence scores.

10. The system of claim 9, further comprising:
obtaining the weights for the weighted sum of confidence scores from a machine learning model trained to generate to classify messages as including or not including content of respective events.

11. The system of claim 8, wherein generating a location confidence score for a message comprises:
receiving a message location for the message, wherein the message location is a location where the message was authored on the user device or a location from which the message was sent to be received by the platform; and
generating a location score that represents a measure of confidence in the accuracy of the message location.

12. The system of claim 8, wherein generating a location confidence score for a message comprises:
determining whether device location information representing the location of the user device at the time the message was sent to the platform is available from the user device;
in response to determining that the device location information is available, generating the location confidence score to represent a high measure of confidence; and
otherwise, generating the respective location confidence score to represent a measure of confidence lower than had the device location information been available.

13. The system of claim 8, wherein generating the media confidence score for a message comprises:
determining whether the media content in the message was captured using client software previously designated by the platform as trustworthy;
in response to determining that the media content was captured using client software previously designated by the platform as trustworthy, generating the media confidence score to represent a high measure of confidence; and
otherwise, generating the media confidence score to represent a measure of confidence lower than had the media content in the message been captured using the client software.

14. The system of claim 8, wherein the plurality of confidence scores comprises a media similarity confidence score for each message that represents a measure of similarity between (i) the media content in the message and (ii) reference media content associated with the event.

15. One or more computer-readable storage media encoded with instructions that, when executed by one or more computers, cause the one or more computers to perform operations comprising:
obtaining, by a social messaging platform, event data, the event data identifying an event, a location of the event, a time of the event, and one or more topics associated with the event;
receiving, by the platform, a plurality of messages from respective user devices, each message including respective media content and at least one topic of the one or more topics, wherein each message is associated with a respective origination location;
generating, by the platform and for each of the plurality of messages, a plurality of respective confidence scores, each confidence score representing a distinct measure of confidence that the message comprises content captured at the event, the confidence scores including a media confidence score and a location confidence score, wherein the media confidence score for a message represents a measure of confidence that the media content in the message was recorded at the location and the time of the event and the location confidence score for a message represents a measure of confidence in the accuracy of a respective location associated with the message;
receiving, by the platform, a request for content relating to the event; and
providing, in a response to the request, a stream of responsive messages, wherein the responsive messages each include one or more of the at least one topics, wherein messages of the stream are provided in a ranked order according to a combination of the plurality of confidence scores.

16. The computer-readable media of claim 15, wherein the combination of the plurality of confidence scores is a weighted sum of the confidence scores.

17. The computer-readable media of claim 16, further comprising:
obtaining the weights for the weighted sum of confidence scores from a machine learning model trained to generate to classify messages as including or not including content of respective events.

18. The computer-readable media of claim 15, wherein generating a location confidence score for a message comprises:
receiving a message location for the message, wherein the message location is a location where the message was authored on the user device or a location from which the message was sent to be received by the platform; and
generating a location score that represents a measure of confidence in the accuracy of the message location.

19. The computer-readable media of claim 15, wherein generating a location confidence score for a message comprises:
determining whether device location information representing the location of the user device at the time the message was sent to the platform is available from the user device;
in response to determining that the device location information is available, generating the location confidence score to represent a high measure of confidence; and
otherwise, generating the respective location confidence score to represent a measure of confidence lower than had the device location information been available.

20. The computer-readable media of claim 15, wherein generating the media confidence score for a message comprises:
determining whether the media content in the message was captured using client software previously designated by the platform as trustworthy;
in response to determining that the media content was captured using client software previously designated by the platform as trustworthy, generating the media confidence score to represent a high measure of confidence; and
otherwise, generating the media confidence score to represent a measure of confidence lower than had the media content in the message been captured using the client software.

21. The computer-readable media of claim 15, wherein the plurality of confidence scores comprises a media similarity confidence score for each message that represents a measure of similarity between (i) the media content in the message and (ii) reference media content associated with the event.
